(19) United States
(12) Patent Application Publication
(10) Pub. No.: US 2008/0174694 A1
(43) Pub. Date: Jul. 24, 2008

(54) Method and apparatus for video pixel interpolation

(75) Inventors: Amir Morad, Tel-Aviv (IL); Leonid Yavits, Herzlia (IL); Ilan Dimnik, Rishon-LeZion (IL); Gedalia Oxman, Tel-Aviv (IL)

Correspondence Address: Martin D. Moynihan;PRTSI, Inc., P.O. Box 16446, Arlington, VA, 22215, US

(73) Assignee: Horizon Semiconductors Ltd., Herzlia (IL)

(21) Appl. No.: 11/655,952

(22) Filed: Jan. 22, 2007

(51) Int. Cl. H04N 7/01; G06K 9/40

(52) U.S. Cl. 348/448; 348/441; 382/255; 382/266; 348/E07.003

(57) ABSTRACT

Video format transformation apparatus including a field/frame assessment module, for associating a field/frame value with a specific pixel. A first value is associated with the specific pixel based on a first function of a group of pixels in proximity to the specific pixel, the group of pixels being in a video frame which includes the specific pixel. A second value is associated with the specific pixel based on a first result and a second result. The first result is of a second function of a second group of pixels, including pixels of an even parity video field within the video frame. The second result is of the second function of a third group of pixels, including pixels of an odd parity video field within the video frame. The field/frame value is associated with the specific pixel based on a third function of the first value and the second value. Related apparatus and methods are also described

### FIELD OF THE INVENTION

The present invention relates to video pixel interpolation, and, more particularly, but not exclusively, to deinterlacing, image scaling, video frame interpolation, and image enhancement.

### BACKGROUND OF THE INVENTION

A video frame is an image made up of a two-dimensional discrete grid of pixels (picture elements). A video sequence is a series of video frames displayed at fixed time intervals.

A scan mode is an order in which the pixels of each video frame are presented on a display. Video is generally displayed in one of two scan modes: progressive or interlaced. In the progressive scan mode every line of the video image is presented, also termed refreshed, in order from a top of the video frame to a bottom of the video frame. The progressive scan mode is typically used in computer monitors and in high definition television displays. In the interlaced scan mode the display alternates between displaying even lines in order from a top of the video frame to a bottom of the video frame and odd lines of the video frame in the same order.

A term “field” is used to describe a portion of a video frame displayed using the interlaced scan mode, with an “even” parity field containing all the even lines of the video frame and an “odd” parity field containing all the odd lines of the video frame. “Top field” and “bottom field” are also used to denote the even parity field and the odd parity field, respectively. Throughout the present specification and claims a pixel will be termed to have parity equal to a parity of a video line, and video field, in which the pixel is comprised.

The term “interlaced scan mode” is used throughout the present specification and claims interchangeably with the term “interlaced mode” and the term “interlaced”.

The term “progressive scan mode” is used throughout the present specification and claims interchangeably with the term “progressive mode” and the term “progressive”.

Interlaced television standards such as, for example, ITU-R BT.470-6, and ITU-R BT. 1700, number the first line of the first field as 1. However, a standard convention in the industry is to start enumeration at zero, numbering the first line as line 0 and the second line as line 1. The present specification uses the standard convention. Thus, the first line is termed even and the second line is termed odd.

While interlacing succeeds in reducing the transmission bandwidth, interlacing also introduces a number of spatial-temporal artifacts which are distracting to the human eye, such as line crawl and interline flicker. In addition, there are a number of applications where interlaced scanning is unacceptable. For instance, trick plays, such as freeze frame, frame by frame playback, slow motion playback in DVD and personal video recorders, require an entire video frame to be displayed. With advances in technology, it is also becoming more popular to view video on a computer monitor or a high definition television set, both of which are progressively scan displays. The above-mentioned modes of viewing require interlaced to progressive conversion.

When a US television standard was introduced in 1941, interlaced scanning, also termed interlacing, was used as a compromise between video quality and transmission bandwidth. An interlaced video sequence appears to have the same spatial and temporal resolution as a progressive video sequence, and takes up half the bandwidth. Interlacing takes advantage of the human visual system, which is more sensitive to details in stationary regions of a video sequence than in moving regions. Prior to introduction of a U.S. High Definition Television (HDTV) standard in 1995, interlaced scanning had been adopted in most video standards. As a result, interlacing is still widely used in various video systems, from studio cameras to home television sets.

Video pixel interpolation refers to computing a value of a pixel between neighboring pixels, both within a single video frame, and interpolating between video frames. Video pixel interpolation is useful, by way of a non-limiting example, in deinterlacing, image scaling, and so on. The issue of deinterlacing is described below.

Deinterlacing is a process of converting interlaced video, which is a sequence of fields, into a non-interlaced form, which is a sequence of video frames. Deinterlacing is a fundamentally difficult process which typically produces image degradation, since deinterlacing ideally requires “temporal interpolation” which involves guessing movements of all moving objects in an image, and applying motion correction to every object.

By way of a non-limiting example, one case where deinterlacing is useful is when displaying video on a display which supports a high enough refresh rate that flicker isn't perceivable. Another case where deinterlacing is useful is when a display cannot interlace but must draw an entire screen each time.

All current displays except for interlaced CRT screens require deinterlacing.

Combining two interlaced fields into one video frame is a difficult task because the two fields are captured at different times.

Reference is now made to FIG. 1, which is a simplified illustration of a moving object in a video frame, displayed on a display operating in a scan mode which is compatible with the scan mode of a video capture device.

The pixels depicting the moving object of FIG. 1 will generally be displayed as in FIG. 1 if both the display and the video capture device operate in progressive scan mode, or if both the video capture device and the display operate in interlaced scan mode.

Reference is made to FIG. 2, which is a simplified illustration of pixels in a video frame 200 captured by video capture device using interlaced scan mode, and displayed on a progressive scan device using a field insertion, or weave, method of combining two video fields.

FIG. 2 presents results of a simple method for combining two video fields (not shown). The two video fields are combined into one video frame 200 using pixel values taken from alternate lines of the two fields as-is, with no change in pixel values. Lines from a top video field 210 are placed in the one video frame 200 alternating with lines from a bottom video field 220.

The weave method is a good solution for a video sequence depicting no moving objects. However, in the one video frame 200 of FIG. 2, a moving object is depicted, and the weave method of combining the two video fields has produced a serrated edge in the object.

Using weave, an original image's vertical and horizontal spatial frequencies are preserved. However, moving objects are not shown at the same position for odd and even lines of the one video frame. Weave causes serration of edges of moving bodies, which is a very annoying artifact.

A desire to eliminate interlacing artifacts provides motivation for developing methods for deinterlacing, or interlaced to progressive conversion.

Reference is now made to FIG. 3, which is a simplified illustration of a deinterlacing method termed “bob”.

Bob is another popular deinterlacing method used for PC and TV progressive scan displays. Bob is also termed line averaging. In the bob method, a top field, comprising pixels 310 and 320 is copied into a progressive scan video frame as is, while a bottom field is created by averaging two adjacent lines of the top field, thus producing pixel 330. A big disadvantage of the bob method is that vertical spatial resolution of the original image is reduced by half in order to make inter-field motion artifacts less visible.

Reference is now made to FIG. 4, which is a simplified illustration of a method of combining two video fields termed Vertical Temporal (VT).

The VT filtering method is a temporal-spatial method which uses co-located pixels of temporally adjacent fields, and neighboring pixels of a current field. Co-located pixels are pixels that are located at the very same spatial coordinates (x, y) of a temporally adjacent video frame or field.

In FIG. 4, pixels 310 and 320 belong to a top field of a current video frame, as described above with reference to FIG. 3. Pixel 430 is a co-located pixel which belongs to a bottom field of the same video frame or the bottom field of a video frame just preceding the current video frame. The value of an output pixel 440 is computed based on the values of spatially neighboring pixels 310 and 320 and co-located and temporally adjacent pixel 430.

In one form of VT filtering, called VT median filtering, a median operation is used to compute the value of the output pixel 440, rather than a linear combination or average of the neighboring and co-located pixels. VT median filtering is depicted in FIG. 4

VT median filtering has become very popular due to its ease of implementation. The simplest example of a VT median filter is a method also named a 3-tap method, as depicted in FIG. 4. To calculate the output pixel 440, the median of the two vertically adjacent pixels 310 320 and the co-located temporally adjacent pixel 430 is calculated.

Sometimes, a larger number of temporal neighbors and their combinations are used in the median filtering. However, VT median filtering produces good visual results for low-motion or no motion scenes, while for high-motion scenes, VT median filtering results in multiple visual artifacts.

Reference is now made to FIG. 5, which is a simplified block diagram illustration of a prior art motion-adaptive deinterlacing system 500. Various features of the system of FIG. 5 are described in “Deinterlacing—An Overview”, by Gerard De Haan and Erwin B. Bellers, in Proceedings of the IEEE, Vol. 86, No. 9, September 1998, the disclosure of which is hereby incorporated herein by reference.

The deinterlacing system 500 comprises a spatial deinterlacing unit 505, a temporal deinterlacing unit 510, a motion detection unit 515, and an output generator 520.

The spatial deinterlacing unit 505 accepts input of top fields of interlaced video via a top field input 525, and provides output A 540 which is provided as input to the output generator 520.

The temporal deinterlacing unit 510 accepts input of bottom fields of interlaced video via a bottom field input 530, and provides output B 545 which is provided as input to the output generator 520.

The motion detection unit 515 accepts input of both top fields and bottom fields, via combined input 535, and provides an output α550 which is provided as input to the output generator 520.

Persons skilled in the art will appreciate that the top field input 525, the bottom field input 530, the combined input 535, the output A 540, the output B 545, and output α550, can be provided one pixel at a time, or more than one pixel at a time, by way of a non-limiting example, one line at a time, several lines at a time, a field at a time, a video frame at a time, or even more. Persons skilled in the art will appreciate that the spatial deinterlacing unit 505, the temporal deinterlacing unit 510, and the motion detection unit 515, comprise suitable buffers, and the spatial deinterlacing unit 505, the temporal deinterlacing unit 510, and the motion detection unit 515 are configured to suitably keep track of locations of each pixel used in performing computation.

The spatial deinterlacing unit 505 uses the bob method to produce spatial average output A 540.

The temporal deinterlacing unit 510 uses the weave method to produce temporal prediction output B 545. By using the weave method, the temporal deinterlacing unit 510 essentially outputs pixels from the bottom field as-is, without changing their values.

The motion detection unit 515 uses any suitable combination of software and hardware, as is well known in the art, to estimate how much motion is present in a video stream.

For example, motion estimation is performed by calculating differences between each pixel of two consecutive fields. Unfortunately, due to noise, the difference is not zero in all image locations without motion. A histogram of the differences for an entire image is produced, and a cutoff level is determined, based at least partly on the histogram, for indicating motion. The result of motion estimation, in a form of a parameter a ranging from 0 to 1, with 0 representing no motion and 1 representing strong motion, is provided as output α550, which is fed to the output generator 520. The parameter a is not a strict probability value, but an arbitrary measure of confidence that a pixel is associated with a depiction of a moving object in the image.

The output generator 520 uses input A 540, input B 545, and input α550 to produce an output O using the following Equation:

O=α*A+(1−α)*B (Equation 1)

The output generator 520 computes a value O for all the pixels of bottom fields. The output of the output generator 520 is provided via output 555 as progressive scan mode video.

In the presence of a substantially large amount of motion in the video stream, the output O is substantially equal to A, which is the output of the spatial deinterlacing unit 505. In this case, the vertical spatial resolution of the resultant progressive scan image suffers, but motion artifacts are not produced by the deinterlacing system 500.

If no substantial amount of motion is present in the video stream, the output O is substantially equal to B, which is the output of the temporal deinterlacing unit 510, resulting in vertical resolution of the resultant progressive scan image being preserved.

If the video stream comprises a moderate amount of motion, a linear combination of temporal prediction and spatial averaging is used.

Persons skilled in the art will appreciate that the computations performed by spatial deinterlacing unit 505, temporal deinterlacing unit 510, and the motion detection unit 515, are performed on a per-pixel basis, using values of neighboring and temporally adjacent pixels as described above.

Persons skilled in the art will appreciate that the outputs of spatial deinterlacing unit 505, temporal deinterlacing unit 510, and the motion detection unit 515, comprise values for each pixel, regardless of whether the output is produced and transmitted one pixel at a time or more than one pixel at a time, as described above.

One disadvantage of the above-mentioned method of the deinterlacing system 500 is that motion cannot be estimated precisely on a per-pixel basis, therefore a likelihood of providing an ill-suited output O is high, causing the deinterlacing system 500 to produce an inferior deinterlaced progressive scan video image, with motion artifacts and poor vertical resolution.

An additional type of interpolation is required in modern digital TVs (DTVs), where video is input at a lower video frame rate than DTV can support. In such a case, typically the video frame rate of the input video is converted to match a video frame rate supported by DTV. Typical cases include conversion from 24, 30 or 60 video frames per second of video to 72 Hz or 120 Hz DTV video frame rate.

There are few methods of video frame rate conversion known in art. One method is based on insertion of “black” video frames in between existing video frames. Another method calls for repeating video frames or fields in order to match the rate of the DTV. More advanced methods are based on interpolating successive video frames to produce missing video frames. Persons skilled in the art will appreciate that such methods need to take into account motion between successive video frames to maintain a high video quality level.

There is thus a widely recognized need for, and it would be highly advantageous to have, a deinterlacing, image scaling, video frame interpolation, and image enhancement apparatus and method devoid of the above limitations.

The disclosures of all references mentioned above and throughout the present specification, as well as the disclosures of all references mentioned in those references, are hereby incorporated herein by reference.

### SUMMARY OF THE INVENTION

The present invention seeks to provide an improved video frame interpolation, deinterlacing, image scaling, and image enhancement system.

According to one aspect of the present invention there is provided a video format transformation apparatus including a field/frame assessment module operative to associate a field/frame value with a specific pixel, the associating a field/frame value including associating a first value with the specific pixel, based, at least in part, on a result of computing a first function of a first group of pixels in proximity to the specific pixel in a video frame including the specific pixel, associating a second value with the specific pixel, based, at least in part, on a first result and a second result, the first result being a result of computing a second function of a second group of pixels, the second group of pixels including pixels of an even video field included in the video frame, and the second result being a result of computing the second function of a third group of pixels, the third group of pixels including pixels of an odd video field included in the video frame, and associating the field/frame value with the specific pixel, based, at least in part, on a third function of the first value and of the second value.

According to another aspect of the present invention there is provided a method for video format transformation, the method including associating a field/frame value with a specific pixel, the associating a field/frame value including associating a first value with the specific pixel, based, at least in part, on a result of computing a first function of a first group of pixels in proximity to the specific pixel, the first group of pixels being in a video frame which includes the specific pixel, associating a second value with the specific pixel, based, at least in part, on a first result and a second result, the first result being a result of computing a second function of a second group of pixels, the second group of pixels including pixels of an even video field included in the video frame, and the second result being a result of computing the second function of a third group of pixels, the third group of pixels including pixels of an odd video field included in the video frame, and associating the field/frame value with the specific pixel, based, at least in part, on a third function of the first value and of the second value.

According to yet another aspect of the present invention there is provided a method for transforming an input of interlaced scan mode video to an output of progressive scan mode video, on a pixel by pixel basis, including producing a first value based, at least in part, on values of a plurality of pixels neighboring an output pixel within an even input video field, producing a second value based, at least in part, on values of one or more pixels neighboring the output pixel within an odd input video field, producing a third value based, at least in part, on values of pixels neighboring the output pixel, and producing an output value for the output pixel based, at least in part, on the first value, the second value, and the third value.

According to another aspect of the present invention there is provided a method for transforming an input of interlaced mode video to an output of progressive mode video, both the input and the output respectively including pixels, the method including for each pixel in the output generating a first value based, at least partly, on values of a co-located input pixel and of neighboring input pixels within a video field of the input pixel, generating a second value based, at least partly, on values of neighboring input pixels within at least one temporally-neighboring video field of opposite parity to the input pixel, and from the generated first value and second value, producing an optimal value for the pixel in the output.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified illustration of pixels in a video frame, displayed on a display which is operating in a scan mode compatible with the scan mode of a video capture device;

FIG. 2 is a simplified illustration of pixels in a video frame captured by video capture device using interlaced scan mode, and displayed on a progressive scan device using a field insertion, or weave, method of combining two video fields;

FIG. 3 is a simplified illustration of a deinterlacing method termed “bob”;

FIG. 4 is a simplified illustration of a method of combining two video fields termed Vertical Temporal (VT);

FIG. 5 is a simplified block diagram illustration of a prior art motion-adaptive deinterlacing system;

FIG. 6 is a simplified block diagram illustration of a multi-purpose deinterlacing system, constructed and operative in accordance with a preferred embodiment of the present invention;

FIG. 7 is a simplified illustration of deinterlacing along an edge at an angle to scan lines according to the system of FIG. 6;

FIG. 8 is a simplified illustration of pairings of video lines within a video field, and pairings of the video lines within a video frame in the system of FIG. 6; and

FIG. 9 is a graphic illustration comparing a pure interpolation filter with a filter which combines edge enhancement and interpolation, with respect to an effect the filters have on spatial frequency of a video image.

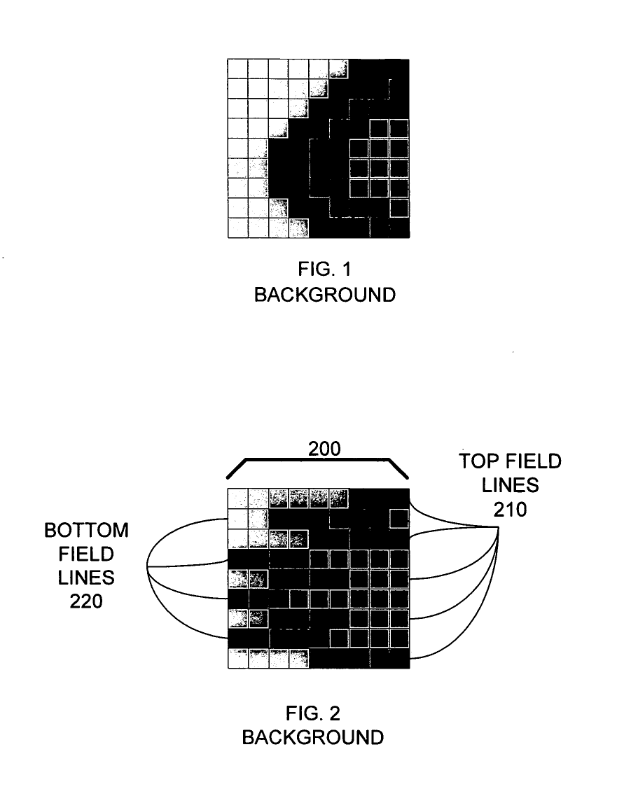

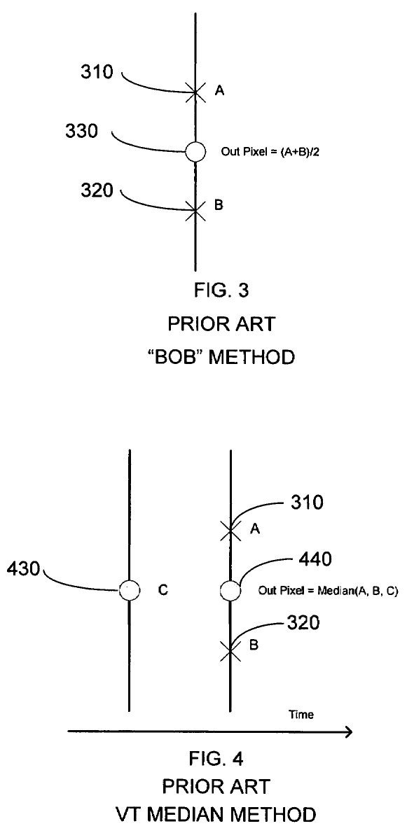

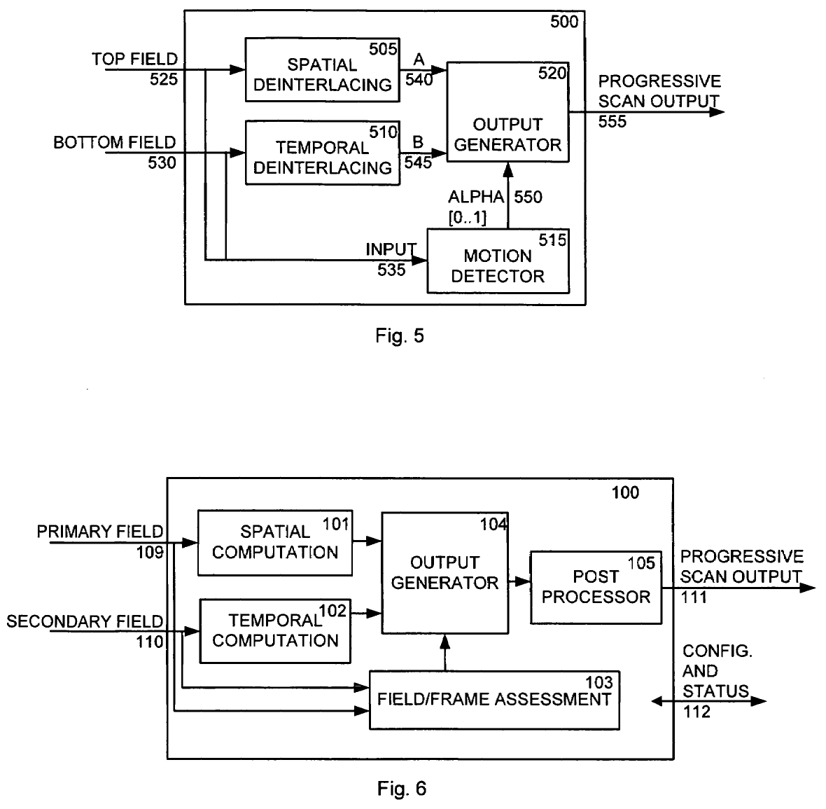

### DESCRIPTION OF PREFERRED EMBODIMENTS

The present embodiments comprise a system and a method for deinterlacing, image scaling, video frame interpolation, and image enhancement.

A preferred embodiment of the present invention transforms an input of interlaced mode video to an output of progressive mode video by producing an optimal value for each pixel in the output, on a pixel by pixel basis.

Additional preferred embodiments of the present invention combine deinterlacing with image resizing and frame interpolation, providing a richer spectrum of video mode and format transformations.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Reference is now made to FIG. 6, which is a simplified block diagram illustration of a multi-purpose deinterlacing system 100, constructed and operative in accordance with a preferred embodiment of the present invention.

The multi-purpose deinterlacing system 100 is comprised of a spatial computation unit 101, a temporal computation unit 102, a field/frame assessment unit 103, an output pixel generator 104 and a post-processor 105.

The multi-purpose deinterlacing system 100 further comprises:

a primary field input 109 which provides input to the spatial computation unit 101 and to the field/frame assessment unit 103;

a secondary field input 110 providing input to the temporal computation unit 102 and to the field/frame assessment unit 103;

a progressive scan mode output 111 providing output from the post processor 105; and

a configuration and status two way interface 112.

Within the multi-purpose deinterlacing system 100, the spatial computation unit 101, the temporal computation unit 102, and the field/frame assessment unit 103 each provide output which is provided as input to the output pixel generator 104. The output pixel generator 104 provides output, the output being input to the post-processor 105.

Persons skilled in the art will appreciate that the input to the multi-purpose deinterlacing system 100, and to each of the components of the multi-purpose deinterlacing system 100, and the output of the multi-purpose deinterlacing system 100 and of each of the components of the multi-purpose deinterlacing system 100, can be any suitable unit of video, such as, and without limiting the generality of the foregoing, a single pixel, a video line, a video field, and a video frame.

The multi-purpose deinterlacing system 100 is preferably configured to operate independently, and also to enable an external controller to use the configuration and status two way interface 112 to configure the multi-purpose deinterlacing system 100, and to monitor the status of the multi-purpose deinterlacing system 100.

The spatial computation unit 101 preferably accepts pixels of one field of a video frame, to be termed herein a primary field, and produces values for “interstitial” pixels to be inserted into an opposite-parity field of a progressive scan video frame.

It is to be appreciated that the primary field can be an even field, and the primary field can alternatively be an odd field. An interlaced video stream comprises a stream of alternating even fields and odd fields. Throughout the present specification and claims wherever even fields and odd fields are mentioned, the mention holds true when the terms even field and odd field are interchanged. Furthermore, throughout the present specification and claims, wherever a first field in a first video frame and a second field in the first video frame are mentioned, the mention holds true for the second field in the first video frame and a first field in a second, immediately following video frame.

In image processing, producing a value for a pixel by computing a linear combination of values of other pixels, usually neighboring pixels, is termed “applying a filter”. By way of a non-limiting example, a value V is computed for a pixel P(x, y) based on applying a filter A as follows:

$$\begin{matrix}V = A * P = ( \begin{matrix}{a}_{0 , 0} & {a}_{1 , 0} & {a}_{2 , 0} \\ {a}_{0 , 1} & {a}_{1 , 1} & {a}_{2 , 1} \\ {a}_{0 , 2} & {a}_{1 , 2} & {a}_{2 , 2}\end{matrix} ) * ( \begin{matrix}{P}_{x - 1 , y - 1} & {P}_{x , y - 1} & {P}_{x + 1 , y - 1} \\ {P}_{x - 1 , y} & {P}_{x , y} & {P}_{x + 1 , y} \\ {P}_{x - 1 , y + 1} & {P}_{x , y + 1} & {P}_{x + 1 , y + 1}\end{matrix} ) \\ = {a}_{0 , 0} {P}_{x - 1 , y - 1} + {a}_{1 , 0} {P}_{x , y - 1} + {a}_{2 , 0} {P}_{x + 1 , y - 1} + \\ {a}_{0 , 1} {P}_{x - 1 , y} + {a}_{1 , 1} {P}_{x , y} + {a}_{2 , 1} {P}_{x + 1 , y} + {a}_{0 , 2} {P}_{x - 1 , y + 1} + \\ {a}_{1 , 2} {P}_{x , y + 1} + {a}_{2 , 2} {P}_{x + 1 , y + 1}\end{matrix} \qquad ( Equation 2 )$$

where α_{x,y} is a value of an x,y coefficient in the example A filter, the A filter being a 3×3 filter; and P_{x,y} is a value of a pixel P at coordinates x,y in a video image.

Persons skilled in the art will appreciate that there are filters designed for different image processing purposes.

Persons skilled in the art will also appreciate that instead of applying a first filter to an image producing an image filtered by the first filter, followed by applying a second filter to the image filtered by the first filter, it is equivalent instead to combine the two filters by performing a mathematical step termed convolution between the two filters, producing a resultant filter, and applying the resultant filter to the image.

In a preferred embodiment of the present invention, the spatial computation unit 101 is preferably composed of a suitable linear interpolation filter. The linear interpolation filter interpolates using, by way of a non-limiting example, vertical interpolation, two-dimensional interpolation, or anti-aliasing interpolation.

In another preferred embodiment of the present invention, the spatial computation unit 101 comprises an adaptive edge detector, with an ability to detect low-angle edges, and interpolation is performed according to a direction of strong edges, thereby preventing visual artifacts such as jagged edges. Artifacts such as jagged edges are especially visible around strong low-angle edges.

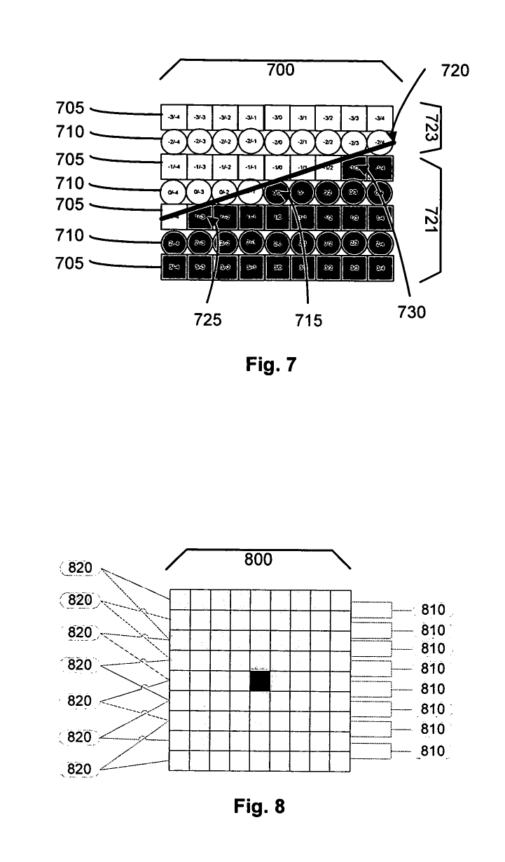

Reference is now additionally made to FIG. 7, which is a simplified illustration of deinterlacing along an edge at an angle to scan lines according to the system of FIG. 6.

FIG. 7 illustrates a problem of a jagged edge and how the jagged edge problem is resolved by interpolation along an edge rather than simple vertical interpolation.

FIG. 7 depicts a section 700 of a video frame, comprising alternating lines of pixels of a primary field 705 and lines of pixels of a secondary field 710. Each of the pixels is marked by x and y coordinates. An interpolated pixel 715, for which a value is to be computed, is located at a center of the section 700, having coordinates (0, 0). The interpolated pixel 715 belongs to a line of pixels of a secondary field 710. The value of the interpolated pixel 715 is computed by the multi-purpose deinterlacing system 100 and produced as output of the multi-purpose deinterlacing system 100.

The section 700 contains an edge 720 between a substantially black area 721 and a substantially white area 723, crossing through the interpolated pixel 715. The edge 720 crosses through several more pixels neighboring on the interpolated pixel 715, including, by way of a non-limiting example, pixels (1,−3) 725, and (−1, 3) 730.

Persons skilled in the art will appreciate that if the value of the interpolated pixel 715 is determined by the spatial computation unit 101 by using vertical interpolation, such as by the “bob” method, the determination of a value for the interpolated pixel 715 is as follows:

P(0, 0)=(P(−1, 0)+P(1, 0))/2 (Equation 3)

Since P(−1, 0) is white, and P(1, 0) is black, Equation 3 determines P(0, 0) to be gray. Therefore, some pixels along the edge 720, according to the “bob” method, are gray, thus producing a succession of black—gray—black pixels along the edge 720, providing a jagged edge appearance, occasionally termed “mice teeth”.

In one preferred embodiment of the present invention the spatial computation unit 101 performs the interpolation along the edge 720, as follows:

P(0, 0)=(P(−1, 3)+P(1,−3))/2 (Equation 4)

Since both pixels P(1, −3) 725 and P(−1, 3) 730 are black, the value of the interpolated pixel 715 P(0, 0) is also black, and the edge appears continuous, solid, and sharp. Typically, sharp and solid edges strongly improve user viewing experience.

In another preferred embodiment of the present invention, the spatial computation unit 101 comprises a two-tap vertical filter, performing spatial computation according to the “bob” method.

In yet another preferred embodiments of the present invention, the spatial computation unit 101 performs computation by performing an image processing filtering operation on the primary field. By way of a non-limiting example, the “bob” method corresponds to using a filter

$$( \begin{matrix}\frac{1}{2} \\ \frac{1}{2}\end{matrix} ) .$$

The “bob” filter is termed a two-tap vertical filter, as mentioned above.

In another preferred embodiment of the present invention, the spatial computation unit 101 uses a multi-tap filter, in which the tap count of the multi-tap filter is substantially larger than two. The multi-tap filter is suitably configured, such that aliasing artifacts are minimized or unnoticeable. By way of a non-limiting example, a simple, linear interpolation, multi-tap filter is:

$$( \begin{matrix}0.0137 \\ - 0.1035 \\ 0.5898 \\ 0.5898 \\ - 0.1035 \\ 0.0137\end{matrix} ) .$$

Persons skilled in the art will appreciate that a multi-tap filter implemented in hardware easily allows filter sizes such as, by way of a non-limiting example, 16×16.

In yet another preferred embodiment of the present invention, the multi-tap filter is combined with an edge enhancing filter. By way of a non-limiting example, a simple edge enhancing filter is:

$$( \begin{matrix}- 0.2000 \\ 1.6248 \\ - 0.2000\end{matrix} ) .$$

By way of a non-limiting example, the simple edge enhancing filter, when convolved with the multi-tap filter described above, provides a combined edge-enhancing interpolation filter as follows:

$$( \begin{matrix}- 0.0027 \\ 0.0429 \\ - 0.2889 \\ 0.8611 \\ 0.8611 \\ - 0.2889 \\ 0.0429 \\ - 0.0027\end{matrix} ) .$$

Reference is again made to FIG. 6. The temporal computation unit 102 preferably accepts pixels of a secondary field. The term secondary field is used in a sense that the secondary field comprises alternate video lines relative to the lines comprised in the primary field. In case of interlaced video, a first secondary field precedes, temporally speaking, a current primary field, and a second secondary field follows, temporally speaking, the current primary field.

The temporal computation unit 102 uses the pixels of the first secondary field and the pixels of the second secondary field to produce a pixel for insertion into an appropriate video line of the progressive scan video frame. The appropriate video line is the same location as a current video line in the temporal computation unit 102, and is interstitial to video lines in the spatial computation unit 101.

In one preferred embodiment of the invention, the temporal computation unit 102 uses a co-located pixel of a temporally-adjacent secondary field as a value for the interstitial pixel. In video images in which there is substantially little or no motion, using co-located pixels of the temporally-adjacent secondary field produces satisfactory deinterlacing results, with no negative impact on vertical resolution of a resultant progressive scan image.

In another preferred embodiment of the present invention, the temporal computation unit 102 uses a combination of co-located pixels from two or more previous and future secondary fields in order to compute the interstitial pixel. The computation is preferably one of: a linear weighted sum of co-located pixels; a median of the co-located pixels; and another suitable combination of the co-located pixels.

In yet another preferred embodiment of the present invention, the temporal computation unit 102 includes a motion estimation unit, designed to track moving objects in video, and locate a position of one or more pixels corresponding to the interstitial pixel in one or more previous and future secondary fields. Based on the motion estimation, a suitable computation based on the one or more corresponding pixels, such as a linear or a non-linear combination of the corresponding pixels, is used to compute the interstitial pixel.

A preferred embodiment of the temporal computation unit 102 includes a linear interpolation filter designed to generate a linear combination of spatially neighboring pixels of one or more secondary fields. A particular case of such a filter is a filter with all coefficients set to zero except for a central coefficient which is set to one. The particular case of such a filter is equivalent to simply transferring a value of a co-located pixel as is, with no processing.

The field/frame assessment unit 103 assesses whether a value for an interstitial pixel is better produced by the spatial computation unit 101, by the temporal computation unit 102, or by a combination of the output values from both the spatial computation unit 101 and the temporal computation unit 102. The field/frame assessment unit 103 receives input from both the primary field input 109 and the secondary field input 110.

In one preferred embodiment of the present invention the assessment is performed on a pixel by pixel basis. In other words, the field/frame assessment unit 103 determines if an individual pixel comes from progressive scan mode or interlaced scan mode surrounding.

In an alternative preferred embodiment of the present invention, the assessment is performed per block of pixels.

For example, and without limiting the generality of the foregoing, a progressive scan mode film-based movie or video clip, with an interlaced scan mode stock ticker line overlaid on top of the progressive scan mode film-based movie or video clip, is likely to comprise portions of the video frame which are in progressive scan mode, and other portions which are in interlaced mode.

In yet another preferred embodiment of the present invention, the field/frame assessment unit 103 provides output pertaining to an entire video frame.

The field/frame assessment unit 103 employs a method of field/frame assessment to evaluate video frames. The method is preferably based on calculating what is termed an “intra-frame correlation”, and what is termed an “intra-field correlation”, and comparing the intra-frame correlation to the intra-field correlation. The intra-frame correlation is a correlation between adjacent lines of a video frame. The intra-field correlation is based on calculating two correlations, each of the two correlations calculated for adjacent lines of a different parity video field within the video frame. If the video frame is of interlaced origin, the intra-field correlation tends to be greater than the intra-frame correlation. The more motion occurs in the time interval between the video fields, the higher the intra-field correlation is relative to the intra-frame correlation. If an evaluated video is of progressive origin, the intra-frame correlation is usually greater than or equal to the intra-field correlation.

In one preferred embodiment of the present invention the intra-field correlation is based on calculating one correlation, of adjacent lines within a single video field.

Persons skilled in the art will appreciate that the field/frame assessment unit 103 generally functions as an inter-field motion detector.

The field/frame assessment unit 103 preferably operates as follows: an image area, preferably rectangular-shaped, surrounding a specific pixel is evaluated. The rectangular image area preferably extends V pixels up and V pixels down from the specific pixel, and H pixels right and H pixels left of the specific pixel.

The field/frame assessment unit 103 calculates a sum S₁ of a function ƒ of a difference between each two pixels in adjacent video frame lines in the evaluation area according to the following equations:

$${S}_{1} = {\sum }_{j = 0}^{( 2 * V + 1 )} {\sum }_{i = 0}^{( 2 * H + 1 )} f ( p ( {x}_{0} - H + i , {y}_{0} - V + j ) - p ( {x}_{0} - H + i , {y}_{0} - V + j + 1 ) ) \qquad ( Equation 5 )$$

where S₁ is the sum of the function ƒ;ƒ is a function of a difference in pixel values; and p (x, y) is a value of a specific pixel at coordinates (x, y).

The field/frame assessment unit 103 also calculates, preferably in parallel, a sum S₂ of a function g of a difference between each two pixels in adjacent video field lines in the evaluation area according to the following equation:

$${S}_{2} = {\sum }_{j = 0}^{( 2 * V )} {\sum }_{i = 0}^{( 2 * H + 1 )} g ( p ( {x}_{0} - H + i , {y}_{0} - V + j ) - p ( {x}_{0} - H + i , {y}_{0} - V + j + 2 ) ) \qquad ( Equation 6 )$$

where S₂ is the sum of the function g; g is a function of a difference in pixel values; and p (x, y) is a value of a specific pixel at coordinates (x, y).

Reference is now made to FIG. 8, which is a simplified illustration of pairings of video lines within a video field, and pairings of the video lines within a video frame in the system of FIG. 6.

FIG. 8 depicts a rectangular area 800, comprising pixels from a video frame. Adjacent video frame lines 810 correspond to the adjacent video frame lines of Equation 5, and adjacent video field lines 820 correspond to the adjacent video field lines of Equation 6.

In one preferred embodiment of the present invention, the functions ƒ and g are absolute difference functions, as in Equation 7 below:

ƒ=g=|p(x₁,y₁)−p(x₂,y₂)| (Equation 7)

In an alternative preferred embodiment of the present invention, ƒ and g are a square difference function as in Equation 8 below.

ƒ=g=(p(x₁,y₁)−p(x₂,y₂))² (Equation 8)

In other alternative preferred embodiments of the present invention, ƒ and g are any another suitable function known in the art for evaluating correlation.

In yet another alternative preferred embodiment of the present invention, S₁ and S₂ are computed using spatial autocorrelation functions as used in image processing. S₁ is computed for the image area, preferably rectangular-shaped, surrounding the specific pixel within the video frame. S₂ is computed for the image area, preferably rectangular-shaped, surrounding the specific pixel within the field comprising the specific pixel.

The field/frame detector unit 103 further calculates a function Φ(S₁, S₂). In one preferred embodiment of the invention, Φ is a binary function returning one of two values, the two values corresponding to “field” or “frame”, as follows:

if(W₁*S₁>W₂*S₂) then Φ=“field” else Φ=“frame”;

where W₁ and W₂ are weighting coefficients.

In one preferred embodiment of the present invention the weighting coefficients are constant, such as, by way of a non-limiting example, equal to one.

In another preferred embodiment of the present invention the weighting coefficients are variable, adjusting adaptively based on image contents, examined area and other parameters.

In another preferred embodiment of the invention, Φ(S₁, S₂) is a continuous function returning values ranging from 0 (strong frame correlation and no inter-field motion) to 1 (strong field correlation and strong inter-field motion).

Persons skilled in the art will appreciate that different combinations of the weighting coefficients W₁ and W₂ and of the function Φ(S₁, S₂) produce different qualities of resultant video. The different qualities of resultant video are the resultant video appearance of sharpness, blurriness, level of detail, smoothness of motion, and so on. A preferred embodiment of the present invention enables keeping a plurality of sets of the weighting coefficients W₁ and W₂ and functions Φ(S₁, S₂), the sets being used according to input from the configuration and status two way interface 112 to the field/frame assessment unit 103. The result of using different sets as described above is a different viewer perception of an output video.

Persons skilled in the art will appreciate that selection of which set of the weighting coefficients W₁ and W₂ and of the function Φ(S₁, S₂) is used by the field/frame assessment unit 103 can be performed by human user intervention, through the configuration and status two way interface 1 12.

Reference is again made to FIG. 6. The output pixel generator 104 is designed to provide a value for the interstitial pixel based on inputs from an output of the spatial computation unit 101, and an output of the temporal computation unit 102. The output pixel generator 104 determines whether to use one of the inputs or a combination of the inputs on a pixel by pixel basis.

In one preferred embodiment of the present invention, the determination is binary. The input from the spatial computation unit 101 provides the value for the output pixel if Φ=“field”. Alternatively, the input from the temporal computation unit 102 provides the value for the output pixel if Φ=“frame”.

In another preferred embodiment of the present invention, the value for output pixel is computed as a combination of the inputs from the spatial computation unit 101 and the temporal computation unit 102 as follows:

P(x, y)=φ*s+(1−Φ)*t (Equation 9)

Where P(x, y) is the value of the output pixel, s is the input from the spatial computation unit 101, t is the input from the temporal computation unit 102, and φ is the input from the field/frame assessment unit 103. It is to be appreciated that φ ranges between 0 and 1, with φ=0 corresponding to strong frame correlation as described above, and φ=1 corresponding to strong field correlation as described above.

In yet another preferred embodiment of the present invention, the output pixel generator 104 examines a record of recent determinations prior to providing a value for an output pixel. If most of the pixels in proximity to the output pixel have been determined to be either “field based” or “frame based”, that is, pixels in strong field correlation or strong frame correlation areas of an image, the determination of the output pixel is based, at least in part, on the record, such that a continuity of the determinations is maintained. Such an approach minimizes visual artifacts which are caused by frequent switching between temporal and spatial interpolation within continuous areas of a video image.

The post-processor 105 reduces visual artifacts caused by, amongst other causes, deinterlacing, and enhances overall video quality of a processed image. The post-processor 105 implements linear and non-linear image processing and enhancement techniques in order to enhance the video quality.

In one preferred embodiment of the present invention, the post-processor 105 comprises an adaptive linear filter designed to enhance and emphasize edges. Persons skilled in the art will appreciate that the adaptive linear filter can be a vertical filter or a two dimensional filter.

Since deinterlacing using spatial-only computation causes degradation in vertical resolution, and since the degradation results in visual “softening” of the video image, the edge enhancement filter is used to emphasize edges in the video image and create a visual perception of a sharper image. The edge enhancement filter is designed so that coefficients of the filter are adjusted adaptively. If temporal computation is predominantly used in certain areas of the image, which are static areas, the edge enhancement filter coefficients are adjusted to have little or no effect. Alternatively, if spatial computation is predominantly used in certain areas of the image, such as, by way of a non-limiting example, high inter-field motion areas, the edge enhancement filter coefficients are adjusted to have more effect.

Referring again to FIG. 6, the output of the post processor 105, which is processed progressive scan mode video, is provided as output to the progressive scan mode output 111.

A motion adaptive deinterlacing application using the multi-purpose deinterlacing system 100 of FIG. 6 will now be described.

In deinterlacing mode, the multi-purpose deinterlacing system 100 operates as follows: a primary field is fed into the spatial computation unit 101, and a secondary, opposite parity, field is fed into the temporal computation unit 102. Both of the fields, together comprising an interlaced video frame, are also fed into the field/frame assessment unit 103. The spatial and the temporal computations, preferably including scaling and edge enhancement, are performed by the spatial computation unit 101 and the temporal computation unit 102 respectively. The field/frame assessment is performed, preferably per individual pixel, by the field/frame assessment unit 103, based on assessment of intra-field correlation vs. intra-frame correlation in the interlaced video frame. The output value of an output pixel is provided by the output pixel generator 104. The output progressive video frames are produced at substantially the rate of the incoming interlaced video frames.

In a preferred embodiment of the present invention, the edge enhancement filter is combined with filters used in the spatial computation unit 101 and in the temporal computation unit 102.

In order to combine filters, filter coefficients are calculated by convolving an original spatial or temporal calculation filter with additional filters, such as the edge enhancement filter.

If image scaling, or re-sizing, is also performed, the spatial computation unit 101 and the temporal computation unit 102 are provided with suitable instructions through the configuration and status two way interface 112. By way of a simple non-limiting example, in order to re-size an image by a factor of 5/3, the spatial computation unit 101 and the temporal computation unit 102 each produce two blank video lines between every three input video lines, producing a total of five video lines, and apply a suitable anti-aliasing filter to the five video lines to interpolate values for the two blank video lines. The spatial computation unit 101 and the temporal computation unit 102 optionally use a filter which combines edge enhancing, as described above. Persons skilled in the art will appreciate that other cases of re-sizing, both enlarging and shrinking an image, are performed similarly.

Persons skilled in the art will appreciate that image scaling can also be performed in the post-processor 105, by providing the post-processor 105 with suitable instructions through the configuration and status two way interface 112.

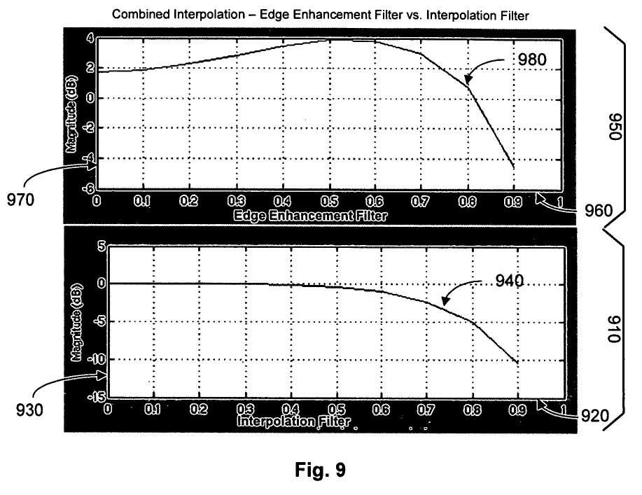

Reference is now made to FIG. 9, which is a graphic illustration comparing a pure interpolation filter with a filter which combines edge enhancement and interpolation, with respect to an effect the filters have on spatial frequency of a video image.

A bottom graph 910 is a graph of the effect a purely spatial interpolation filter has on spatial frequency in a video image. The bottom graph 910 comprises a horizontal axis 920 and a vertical axis 930. The horizontal axis 920 is of normalized spatial frequency in a video image, with the highest spatial frequency in the video image corresponding to 1. The vertical axis 930 is of attenuation in units of dB. A line 940 across the bottom graph 910 shows that a spatial interpolation filter does not attenuate low spatial frequencies in a video image, and does attenuate high spatial frequencies in a video image.

It is to be appreciated that the line 940 in the bottom graph 910 is also true for an image scaling embodiment of the present invention, since image scaling, both enlarging an image and shrinking an image, uses low pass filtering.

A top graph 950 is a graph of the effect a combined spatial interpolation and edge enhancement filter has on spatial frequency in a video image. The top graph 950 comprises a horizontal axis 960 and a vertical axis 970. The horizontal axis 960 is the same as the horizontal axis 920 of the bottom graph 910. The vertical axis 970 uses the same units as the vertical axis 930 of the bottom graph 910, displaying a different range of attenuation. A line 980 across the top graph 950 shows that a combined spatial interpolation and edge enhancement filter emphasizes middle spatial frequencies before attenuating high spatial frequencies in the video image. Persons skilled in the art will appreciate that the line 980 does not start at 0 dB, which does not change the substance of the top graph 950 and does not change the comparison of the top graph 950 to the bottom graph 910.

Persons skilled in the art will appreciate that using the purely spatial interpolation filter, as well as using a scaling filter, suppresses high frequencies, typically in order to remove an aliasing effect, and that a combined edge enhancement, spatial interpolation, and scaling filter emphasizes middle-upper spatial frequencies and suppresses high spatial frequencies. Such filtering produces a visual effect of a sharper image, with emphasized edges, but can also add some high-frequency noise which normally has limited effect on user viewing experience.

In a preferred embodiment of the present invention, filter configuration parameters, such as, by way of a non-limiting example, the filter's IIR (Infinite Impulse Response), FIR (Finite Impulse Response), coefficients, numbers of taps, and so on, are programmable and adaptively adjustable. The adaptive adjustment is based at least in part on image content, inter-field and intra-field motion, user preference, and so on, such that an optimal trade-off between sharpness of the image and aliasing and ringing artifacts is achieved.

In yet another preferred embodiment of the present invention, image scaling is combined with the filters used in the spatial computation unit 101 and in the temporal computation unit 102.

An application of the multi-purpose deinterlacing system 100 of FIG. 6 for simultaneous deinterlacing and resizing video images is now described.

The spatial computation unit 101 is used to simultaneously interpolate a pixel based on values of neighboring pixels and resize an image. In this case the interpolation and resizing is preferably implemented by one polyphase linear filter.

A typical, non-limiting example of simultaneous deinterlacing and resizing occurs when transforming Standard Definition (SD) video, having a resolution of 480 lines and interlace mode scanning, to a High Definition (HD) progressive scan mode resolution of 1080 lines. Persons skilled in the art will appreciate that the concurrent operation saves hardware and power consumption by reducing the number of filters which would be used if the resizing is performed separately from the deinterlacing. Using a single filter step may enhance video quality of the output image, in comparison to using two filters, one for deinterlacing, and one for scaling.

An application of the multi-purpose deinterlacing system 100 of FIG. 6 for video frame interpolation will now be described. Persons skilled in the art will appreciate that a typical, non-limiting, example of video frame interpolation is when a video which was created in 30 frames per second interlaced mode, which is a common television video standard, is transformed to 60 frames per second progressive mode, which is a modern consumer television standard.

In a video frame interpolation mode, the multi-purpose deinterlacing system 100 operates as described below.

A first field of an interlaced video frame is set as a primary field and the primary field is input to the spatial computation unit 101. A second, opposite parity, field is set as a secondary field and the secondary field is input to the temporal computation unit 102. Both of the fields are input into the field/frame assessment unit 103. The spatial and the temporal computation, preferably including resizing and edge enhancement, are performed by the spatial computation unit 101 and the temporal computation unit 102 respectively. A field-frame assessment is performed by the field/frame assessment unit 103, preferably per an individual pixel, based on intra-field correlation vs. intra-frame correlation. The production of interstitial pixels is performed by the output pixel generator 104.

The second, opposite parity, field of the interlaced video frame is then set as the primary field and the primary field is input to the spatial computation unit 101, while the first field is set as the secondary field and the secondary field is input to the temporal computation unit 102. Both of the fields are input to the field/frame assessment unit 103. The spatial and the temporal computation, preferably including resizing and edge enhancement, are performed by the spatial computation unit 101 and the temporal computation unit 102 respectively. The field-frame assessment is performed by the field/frame assessment unit 103, preferably per an individual pixel, based on intra-field correlation vs. intra-frame correlation. The production of interstitial pixels is performed by the output pixel generator 104.

It is to be appreciated that instead of setting the first field of the interlaced video frame as the secondary field, it is possible to set a first field of a following video image frame as the secondary field, and input the secondary field to the temporal computation unit 102.

As described above, the interlaced video is transformed into progressive scan video at double the frame rate of the input video.

Persons skilled in the art will appreciate that the multi-purpose deinterlacing system 100 multiplies frame rate of the video, such that the number of output progressive video frames is, for example, twice the number of input interlaced video frames. For example, 1080(i) video (1920×1080 pixels at 60 fields/sec rate) is converted to 1080(p) video (1920×1080 pixels at 60 video frames/sec), thus significantly improving the visual experience.

In an alternative preferred embodiment of the present invention, temporal computation and field-frame assessment are turned off, and the multi-purpose deinterlacing system 100 uses only the spatial computation unit 101 to up-scale, that is, to increase the vertical size of the image by the factor of two. The spatial computation unit 101 preferably edge-enhances each incoming field of interlaced video, producing progressive video frames at a rate equal to an incoming field rate, which is double an incoming frame rate. Although vertical resolution of each of the progressive video frames is reduced, the sequence of images is temporally filtered by the human eye so that the high quality visual experience will be preserved.

In a preferred embodiment of the present invention, the post-processor 105 preferably performs additional image processing on the video, such as edge enhancement to additionally sharpen the video image, or de-blurring. Persons skilled in the art will appreciate that LCD displays, such as are common today, produce a blurry image, compared to Cathode Ray Tubes (CRTs). The blurry image can be de-blurred using any suitable de-blurring filer, such as, and without limiting the generality of the foregoing, a Wiener filter, a regularized filter, and a Lucy-Richardson filter. Additional image processing to improve the performance of a LCD display may include moire cancellation, LCD dithering and motion stabilization.

In an alternative preferred embodiment of the present invention, such additional linear image processing is performed concurrently with the interpolation and possibly the resizing, using the same combined filters, as described above.

It is expected that during the life of this patent many relevant devices and systems will be developed and the scope of the terms herein, particularly of the terms interlaced scan mode, progressive scan mode, standard definition TV, high definition TV, deinterlacer, filter, and video frames are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Video format transformation apparatus comprising:
a field/frame assessment module operative to associate a field/frame value with a specific pixel, the associating a field/frame value comprising:
associating a first value with the specific pixel, based, at least in part, on a result of computing a first function of a first group of pixels in proximity to the specific pixel in a video frame comprising the specific pixel;
associating a second value with the specific pixel, based, at least in part, on a first result and a second result, the first result being a result of computing a second function of a second group of pixels, the second group of pixels comprising pixels of an even video field comprised in the video frame, and the second result being a result of computing the second function of a third group of pixels, the third group of pixels comprising pixels of an odd video field comprised in the video frame; and
associating the field/frame value with the specific pixel, based, at least in part, on a third function of the first value and of the second value.

2. The apparatus of claim 1 and wherein the second group of pixels comprises pixels of the odd video field comprised in the video frame, and the third group of pixels comprises pixels of the even video field comprised in the video frame.

3. The apparatus of claim 1 and wherein:
the first function is a sum of squares of differences between pairs of pixels from the first group of pixels, each of the pairs of the pixels being comprised of two pixels disposed vertically adjacent to each other within the first group of pixels; and
the second function is a sum of squares of differences between pairs of pixels, the differences being computed between pairs of pixels, each of the pairs of the pixels being comprised of two pixels disposed vertically adjacent to each other within the second group of pixels and within the third group of pixels.

4. The apparatus of claim 1 and wherein:
the first function is a sum of absolute differences between pairs of pixels from the first group of pixels, each of the pairs of the pixels being comprised of two pixels disposed vertically adjacent to each other within the first group of pixels; and
the second function is a sum of absolute differences between pairs of pixels, the absolute differences being computed between pairs of pixels, each of the pairs of the pixels being comprised of two pixels disposed vertically adjacent to each other within the second group of pixels and within the third group of pixels.

5. The apparatus of claim 1 and wherein the first function is an autocorrelation function of pixels of the first group of pixels, and the second function is an autocorrelation function of pixels of only the second group of pixels.

6. The apparatus of claim 1 and wherein the size of the area comprising the pixels located in proximity to the specific pixel is different for different locations of the specific pixel.

7. The apparatus of claim 1 and wherein the third function is different for different locations of the specific pixel.

8. The apparatus of claim 1 and wherein the associating the field/frame value is additionally based, at least in part, on field/frame values associated with pixels neighboring the specific pixel in the video frame.

9. The apparatus of claim 1 and wherein the associating a field/frame value is additionally based, at least in part, on prior field/frame values associated with pixels co-located with the specific pixel in prior video frames.

10. The apparatus of claim 1 and further comprising:
a spatial computation unit operative to associate a spatial value with the specific pixel, based, at least in part, on a result of applying a first image processing operation to the even video field;
a temporal computation unit operative to associate a temporal value with the specific pixel, based, at least in part, on a result of applying a second image processing operation to one or more odd video fields, one of the one or more odd video fields being comprised in the video frame; and
an output unit operative to produce an output of a value for the specific pixel, based, at least in part, on the spatial value, the temporal value, and the field/frame value associated with the specific pixel.

11. The apparatus of claim 10 and wherein:
the spatial computation unit is operative to associate the spatial value with the specific pixel, based, at least in part, on a result of applying the first image processing operation to the odd video field; and
the temporal computation unit is operative to associate the temporal value with the specific pixel, based, at least in part, on a result of applying the second image processing operation to one or more even video fields, one of the one or more even video fields being comprised in the video frame.

12. The apparatus of claim 10 and further comprising a post-processing unit, the post-processing unit operative to accept the output of the output unit and to modify the output of the output unit, thereby producing a modified output.

13. The apparatus of claim 12 and wherein the post-processing unit is operative to apply an image processing operation to the output of the output unit, the image processing operation comprising at least one of the following:
image scaling;
edge enhancement;
de-blurring;
moiré cancellation; and
an LCD dithering operation.

14. The apparatus of claim 10 and wherein the spatial computation unit and the temporal computation unit are comprised in one computation unit.

15. The apparatus of claim 10 and wherein the first image processing operation comprises
a linear interpolation of pixels in a neighborhood of the specific pixel.

16. The apparatus of claim 15 and wherein the first image processing operation additionally comprises at least one of the following:
image scaling;
edge enhancement;
de-blurring;
moiré cancellation; and
an LCD dithering operation.

17. The apparatus of claim 10 and wherein the spatial computation unit and the temporal computation unit are operative to produce a different number of output values than a number of pixels comprised in the video frame, thereby resizing the video frame.

18. The apparatus of claim 10 and wherein the output unit is operative to produce a different number of output values than a number of pixels comprised in the video frame, thereby resizing the video frame.

19. The apparatus of claim 12 and wherein the post-processing unit is operative to produce a different number of output values than a number of pixels comprised in the video frame, thereby resizing the video frame.

20. The apparatus of claim 10 and wherein the second image processing operation comprises linear interpolation of pixels co-located with and neighboring to the specific pixel in the odd video field, and in a previous odd video field.

21. The apparatus of claim 20 and wherein the second image processing operation additionally comprises at least one of the following:
image scaling;
edge enhancement;
de-blurring;
moiré cancellation; and
an LCD dithering operation.

22. The apparatus of claim 10 and wherein:
the spatial computation unit is operative to associate a second spatial value with the specific pixel, based, at least in part, on a result of applying the first image processing operation to the one or more odd video fields;
the temporal computation unit is operative to associate a second temporal value with the specific pixel, based, at least in part, on a result of applying the second image processing operation to the even video field; and
the output unit is operative to produce an output of a second value for the specific pixel, based, at least in part, on the second spatial value, the second temporal value, and the field/frame value associated with the specific pixel.

23. The apparatus of claim 22 and wherein the first image processing operation and the second image processing operation comprise an interpolation operation.

24. The apparatus of claim 23 and wherein the first image processing operation and the second image processing operation comprise an edge enhancement operation.

25. A method for video format transformation, the method comprising:
associating a field/frame value with a specific pixel, the associating a field/frame value comprising:
associating a first value with the specific pixel, based, at least in part, on a result of computing a first function of a first group of pixels in proximity to the specific pixel, the first group of pixels being in a video frame which comprises the specific pixel;
associating a second value with the specific pixel, based, at least in part, on a first result and a second result, the first result being a result of computing a second function of a second group of pixels, the second group of pixels comprising pixels of an even video field comprised in the video frame, and the second result being a result of computing the second function of a third group of pixels, the third group of pixels comprising pixels of an odd video field comprised in the video frame; and
associating the field/frame value with the specific pixel, based, at least in part, on a third function of the first value and of the second value.

26. The method of claim 25 and wherein the second group of pixels comprises pixels of the odd video field comprised in the video frame, and the third group of pixels comprises pixels of the even video field comprised in the video frame.

27. The method of claim 25 and further comprising:
associating a spatial value with the specific pixel, based, at least in part, on a result of applying a first image processing operation to the even video field;
associating a temporal value with the specific pixel, based, at least in part, on a result of applying a second image processing operation to one or more odd video fields, one of the one or more odd video fields being comprised in the video frame; and
producing an output value for the specific pixel, based, at least in part, on the spatial value, the temporal value, and the field/frame value associated with the specific pixel.

28. The method of claim 27 and wherein:
the associating the spatial value with the specific pixel is based, at least in part, on a result of applying the first image processing operation to the odd video field; and
the associating the temporal value with the specific pixel is based, at least in part, on a result of applying the second image processing operation to one or more even video fields, one of the one or more even video fields being comprised in the video frame.

29. The method of claim 27 and further comprising:
associating a second spatial value with the specific pixel, based, at least in part, on a result of applying the first image processing operation to the one or more odd video fields;
associating a second temporal value with the specific pixel, based, at least in part, on a result of applying the second image processing operation to the even video field; and
producing an output of a second value for the specific pixel, based, at least in part, on the second spatial value, the second temporal value, and the field/frame value associated with the specific pixel.

30. A method for transforming an input of interlaced scan mode video to an output of progressive scan mode video, on a pixel by pixel basis, comprising:
producing a first value based, at least in part, on values of a plurality of pixels neighboring an output pixel within an even input video field;
producing a second value based, at least in part, on values of one or more pixels neighboring the output pixel within an odd input video field;
producing a third value based, at least in part, on values of pixels neighboring the output pixel; and
producing an output value for the output pixel based, at least in part, on the first value, the second value, and the third value.

31. A method for transforming an input of interlaced mode video to an output of progressive mode video, both the input and the output respectively comprising pixels, the method comprising:
for each pixel in the output:
generating a first value based, at least partly, on values of a co-located input pixel and of neighboring input pixels within a video field of the input pixel;
generating a second value based, at least partly, on values of neighboring input pixels within at least one temporally-neighboring video field of opposite parity to the input pixel; and
from the generated first value and second value, producing an optimal value for the pixel in the output.
